(19) United States
(12) Patent Application Publication
(10) Pub. No.: US 2022/0178393 A1
(43) Pub. Date: Jun. 9, 2022

(54) LOCKING ASSEMBLY

(71) Applicant: Xiamen Beewill Sanitary Co., Ltd., Xiamen (CN)

(72) Inventor: Shisong REN, Xiamen (CN)

(73) Assignee: Xiamen Beewill Sanitary Co., Ltd., Xiamen (CN)

(21) Appl. No.: 17/543,750

(22) Filed: Dec. 7, 2021

(30) Foreign Application Priority Data
Dec. 8, 2020 (CN) 202011422695.4

(51) Int. Cl. F16B 2/06

(52) U.S. Cl. CPC F16B 2/065

(57) ABSTRACT

A locking assembly includes a retainer and a fastener. The retainer is provided with a sliding groove. The fastener is configured to move in the sliding groove, the fastener has a relative disengagement state and a relative engagement state, the fastener is configured to be accommodated in the retainer when in the relative engagement state, and the fastener is provided with a limiting structure for keeping the fastener at a specific disengagement angle. A toilet including the locking assembly is further provided. The locking assembly and the toilet can be rapidly disassembled and reusable.

### CROSS REFERENCE TO THE RELATED APPLICATIONS

This application is based upon and claims priority to Chinese Patent Application No. 202011422695.4, filed on Dec. 8, 2020, the entire contents of which are incorporated herein by reference.

### TECHNICAL FIELD

The present invention relates to the technical field of fixing devices, and in particular to a locking assembly.

### BACKGROUND

When a cover plate is to be installed on a toilet body, locking assemblies are required, most of which are combinations of expansion bolts and screw rods. To install the cover plate, firstly, the expansion bolt made of plastic or rubber is installed into a reserved hole of the toilet body; then the screw rod penetrates an installation support to be connected to the expansion bolt, to fix the installation support of the cover plate; and finally, a rotary shaft of the cover plate is connected to the installation support, to rotatably install the cover plate. Being made of plastic or rubber, most expansion bolts will creep and loosen after long-term use, and are likely to be damaged when violently installed.

In order to solve the problems described above, some existing locking assemblies are metallic. However, a metal locking assembly cannot be rapidly installed or disassembled, and is likely to be damaged when improperly installed or violently disassembled.

### SUMMARY

The present invention aims to solve one of the technical problems in the art described above at least to a certain extent. Thus, it is an objective of the present invention to provide a locking assembly, which is rapidly disassembled and reusable.

In order to achieve the objective described above, an embodiment of the present invention provides a locking assembly, including:

a retainer, the retainer being provided with a sliding groove; and

a fastener, the fastener being capable of moving in the sliding groove, having a relative disengagement state and a relative engagement state, being capable of being accommodated in the retainer when in the relative engagement state, and being provided with a limiting structure for keeping the fastener at a specific disengagement angle.

According to a locking assembly of the embodiment of the present invention, the fastener is used as a locking abutment, to realize a locking function when in the relative disengagement state; and the fastener may be accommodated in the retainer when in the relative engagement state, to reduce an entire width of the fastener, and thus it is convenient to disassemble the retainer and the fastener integrally, and the locking assembly is rapidly disassembled and reusable.

In addition, a locking assembly according to the embodiment described above of the present invention may further have the following additional technical features:

Further, the fastener is hinged to a hinge shaft, and the hinge shaft may move in the sliding groove.

Further, the retainer is provided with a first sliding rail and a second sliding rail which are oppositely arranged and in communication with each other, a first end of the hinge shaft moving in the first sliding rail, a second end of the hinge shaft moving in the second sliding rail, and the first end and the second end of the hinge shaft being provided with opposite sliding planes separately.

Further, at least one of opposite side walls of one ends, close to the first inclined guide surface and the second inclined guide surface, of the first sliding rail and the second sliding rail is provided with a limiting protrusion point, the limiting protrusion point dividing the first sliding rail and the second sliding rail into upper travel sections and lower travel sections, and the lower travel sections exactly accommodating the hinge shaft.

Further, the locking assembly further includes an actuating positioner, the actuating positioner being connected to the fastener and capable of driving the fastener to move and keeping the fastener at a specific position.

Further, the actuating positioner includes a bolt and a threaded through hole radially formed in the hinge shaft, the bolt penetrating the retainer to be connected to the threaded through hole.

Further, the fastener includes a first fastening sheet and a second fastening sheet, the first fastening sheet and the second fastening sheet being hinged to the hinge shaft separately.

Further, the first fastening sheet and the second fastening sheet include first hinge plates and second hinge plates which are oppositely arranged, and connecting plates for connecting the first hinge plates and the second hinge plates, parts, close to hinge ends, of the connecting plates of the first fastening sheet and the second fastening sheet being provided with cut grooves separately; and the limiting structure enabling an end part of the hinge end of the first hinge plate of the first fastening sheet to be in abutting fit with a bottom of the cut groove of the second fastening sheet, and an end part of the hinge end of the first hinge plate of the second fastening sheet to be in abutting fit with a bottom of the cut groove of the first fastening sheet.

Further, the sliding grooves include a first sliding groove and a second sliding groove which are oppositely arranged and in communication with each other, the first fastening sheet moving in the first sliding groove, and the second fastening sheet moving in the second sliding groove; and the first sliding groove being provided with a first inclined guide surface for engaging the first fastening sheet relative to the second fastening sheet, the second sliding groove being provided with a second inclined guide surface for engaging the second fastening sheet relative to the first fastening sheet, and the first inclined guide surface being opposite the second inclined guide surface.

Further, the fastener includes a third fastening sheet, the third fastening sheet being hinged to the hinge shaft.

Further, the third fastening sheet includes a first hinge plate and a second hinge plate which are oppositely arranged, a connecting plate for connecting the first hinge plate to the second hinge plate, and an abutting plate for connecting hinge ends of the first hinge plate and the second hinge plate; an avoiding space for the bolt to penetrate being arranged between the connecting plate and the abutting plate; and the limiting structure enabling the hinge end of the connecting plate and/or the abutting plate to be in abutting fit with the bolt.

### BRIEF DESCRIPTION OF THE DRAWINGS

FIG. 1 is an exploded perspective view of a locking assembly according to Embodiment 1 of the present invention;

FIG. 2 is an assembled perspective view of the locking assembly according to Embodiment 1 of the present invention;

FIG. 3 is a schematic diagram of the locking assembly in a pre-assembled state according to Embodiment 1 of the present invention;

FIG. 4 is a schematic diagram of the locking assembly in a locking state according to Embodiment 1 of the present invention;

FIG. 5 is a schematic diagram of the locking assembly in an unlocking state according to Embodiment 1 of the present invention;

FIG. 6 is a schematic diagram of the locking assembly, reset and taken out, according to Embodiment 1 of the present invention;

FIG. 7 is a structural schematic diagram of the locking assembly, installed at a toilet, according to Embodiment 1 of the present invention; and

FIG. 8 is an assembled perspective view of a locking assembly according to Embodiment 2 of the present invention.

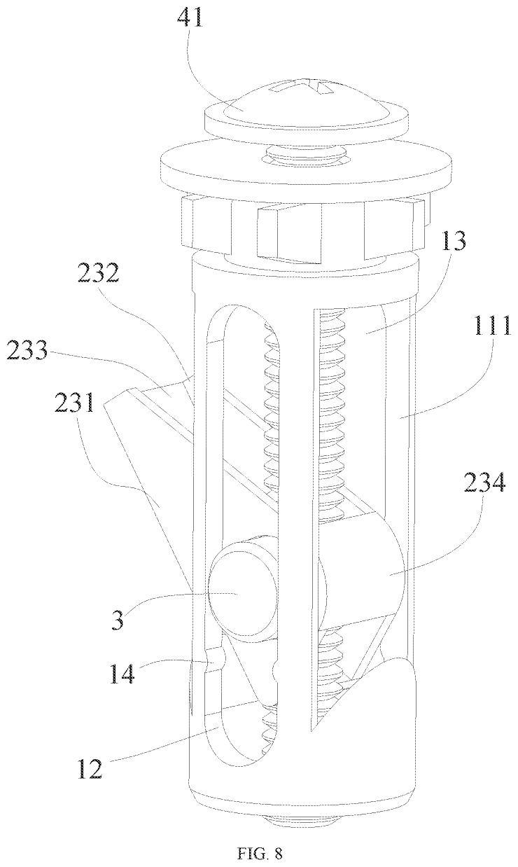

### REFERENCE NUMERALS

locking assembly 10
retainer 1
sliding groove 11
first sliding groove 111
second sliding groove 112
first inclined guide surface 113
second inclined guide surface 114
first sliding rail 12
second sliding rail 13
limiting protrusion point 14
fastener 2
first fastening sheet 21
second fastening sheet 22
first hinge plate (211, 221, 231)
second hinge plate (212, 222, 232)
connecting plate (213, 223, 233)
cut groove (214, 224)
third fastening sheet 23
abutting plate 234
hinge shaft 3
sliding plane 31
actuating positioner 4
bolt 41
threaded through hole 42
support 20
cover plate 30 and
toilet body 40.

### DETAILED DESCRIPTION OF THE EMBODIMENTS

The embodiments of the present invention are described in detail below, the examples of which are illustrated in the accompanying drawings, where the same or similar reference numerals refer to the same or similar elements or elements having the same or similar functions throughout. The following embodiments described with reference to the accompanying drawings are exemplary and intended to explain the present invention, instead of being construed as limiting the present invention.

Disclosed is a locking assembly, including a retainer and a fastener, the retainer being provided with a sliding groove, and the fastener being capable of moving in the sliding groove, having a relative disengagement state and a relative engagement state, being capable of being accommodated in the retainer when in the relative engagement state, and being provided with a limiting structure for keeping the fastener at a specific disengagement angle. The fastener is used as a locking abutment, to realize a locking function when in the relative disengagement state; and the fastener may be accommodated in the retainer when in the relative engagement state, to reduce an entire width of the fastener, and thus it is convenient to disassemble the retainer and the fastener integrally, and the locking assembly is rapidly disassembled and reusable.

In order to better understand the technical solution described above, the exemplary embodiments of the present invention will be described in more detail below with reference to the accompanying drawings. While the exemplary embodiments of the present invention are shown in the accompanying drawings, it should be understood that the present invention may be implemented in various forms without being limited by the embodiments set forth herein. In contrast, these embodiments are provided to gain a more thorough understanding of the present invention and fully convey the scope of the present invention to those skilled in the art.

The technical solution described above will be described in detail below with reference to the accompanying drawings in the description and the specific implementations, to make it better understood.

### Embodiment 1

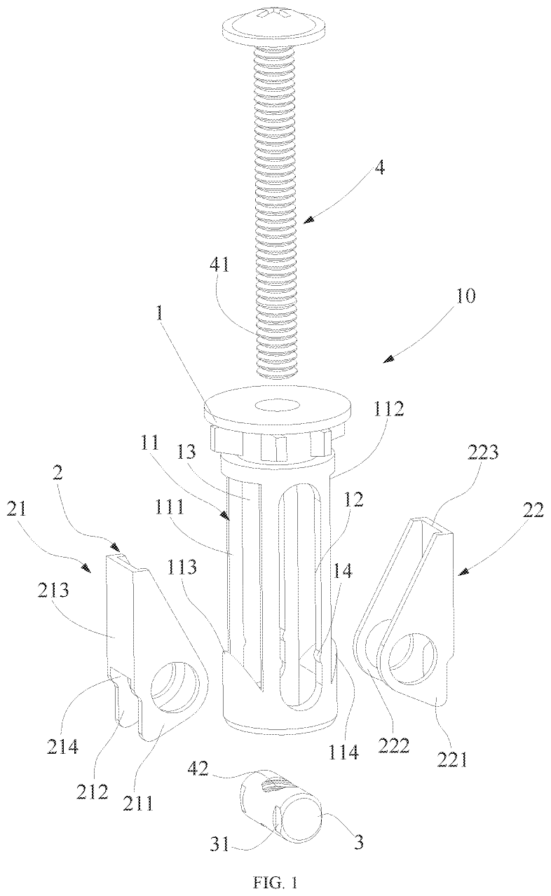

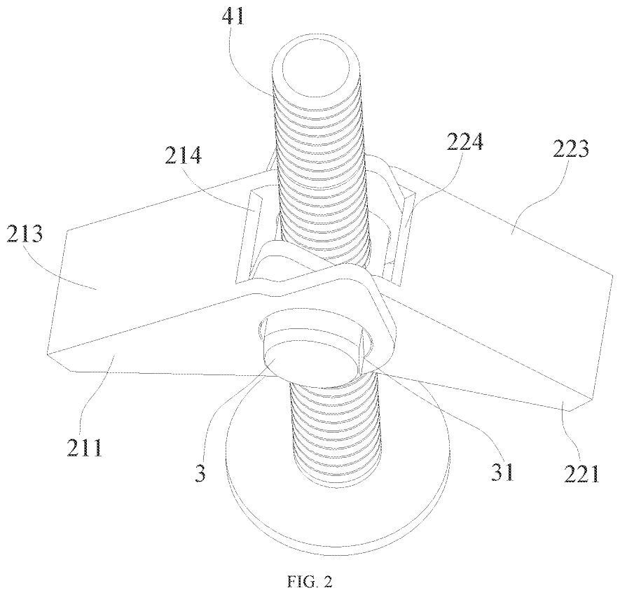

FIG. 1 is an exploded perspective view of a locking assembly, and FIG. 2 is an assembled perspective view of the locking assembly (with an angle opposite that in FIG. 1).

As shown in FIGS. 1 and 2, a locking assembly 10 in Embodiment 1 of the present invention includes a retainer 1 and a fastener 2, the retainer 1 being provided with a sliding groove 11, the fastener 2 being formed by hinging two fastening sheets through a hinge shaft 3, the two fastening sheets being capable of moving in the sliding grooves 11, having a relative disengagement state and a relative engagement state, and being capable of being accommodated in the retainer 1 when in the relative engagement state, and a limiting structure for keeping the two fastening sheets at a specific disengagement angle being arranged between the two fastening sheets. The fastener 2 may be formed by hinging a first fastening sheet 21 and a second fastening sheet 22 through the hinge shaft 3, and the hinge shaft 3 may be a cylindrical nut.

The two fastening sheets are used as locking abutments, to realize a locking function when in the relative disengagement state; and the two fastening sheets may be accommodated in the retainer 1 when in the relative engagement state, to reduce an entire width of the two fastening sheets, and thus it is convenient to disassemble the retainer 1 and the fastener 2 integrally, and the locking assembly is rapidly disassembled and reusable.

As shown in FIG. 2, the first fastening sheet 21 and the second fastening sheet 22 include first hinge plates (211, 221) and second hinge plates (212, 222) which are oppositely arranged, and connecting plates (213, 223) for connecting the first hinge plates (211, 221) and the second hinge plates (212, 222), that is, the first fastening sheet 21 and the second fastening sheet 22 have the same structure, and the first fastening sheet 21 and the second fastening sheet 22 are oppositely arranged, the hinge shaft 3 being connected to the first hinge plates (211, 221) and the second hinge plates (212, 222). Parts, close to hinge ends, of the connecting plates (213, 223) of the first fastening sheet 21 and the second fastening sheet 22 are provided with cut grooves (214, 224) separately. The limiting structure which keeps the first fastening sheet 21 and the second fastening sheet 22 at the specific disengagement angle enables an end part of the hinge end of the first hinge plate 211 of the first fastening sheet 21 to be in abutting fit with a bottom of the cut groove 224 of the second fastening sheet 22, and an end part of the hinge end of the first hinge plate 221 of the second fastening sheet 22 to be in abutting fit with a bottom of the cut groove 214 of the first fastening sheet 21.

In order to install the hinge shaft 3 conveniently, the first hinge plates (211, 221) and the second hinge plates (212, 222) of the first fastening sheet 21 and the second fastening sheet 22 are triangular, and installation holes for the hinge shaft 3 are provided in the first hinge plates (211, 221) and the second hinge plates (212, 222).

In some examples, the sliding grooves 11 include a first sliding groove 111 and a second sliding groove 112 which are oppositely arranged and in communication with each other, the first fastening sheet 21 moving in the first sliding groove 111, and the second fastening sheet 22 moving in the second sliding groove 112. In this way, the fastener 2 moves stably.

The first sliding groove 111 is provided with a first inclined guide surface 113 for engaging the first fastening sheet 21 relative to the second fastening sheet 22, and the second sliding groove 112 is provided with a second inclined guide surface 114 for engaging the second fastening sheet 22 relative to the first fastening sheet 21, the first inclined guide surface 113 being opposite the second inclined guide surface 114. The retainer 1 is generally installed in a vertical direction. The first inclined guide surface 113 and the second inclined guide surface 114 are arranged on bottom side walls of the first sliding groove 111 and the second sliding groove 112 correspondingly. When an actuating positioner 4 moves the first fastening sheet 21 and the second fastening sheet 22 to the first inclined guide surface 113 and the second inclined guide surface 114 respectively, the first fastening sheet 21 is engaged relative to the second fastening sheet 22 when subjected to a pushing action of the first inclined guide surface 113, and meanwhile, the second fastening sheet 22 is engaged relative to the first fastening sheet 21 when subjected to a pushing action of the second inclined guide surface 114. In this way, the fastener 2 may be accommodated in the retainer 1.

In some examples, the retainer 1 is provided with a first sliding rail 12 and a second sliding rail 13 which are oppositely arranged and in communication with each other, a first end of the hinge shaft 3 moving in the first sliding rail 12, and a second end of the hinge shaft 3 moving in the second sliding rail 13. The first end and the second end of the hinge shaft 3 are provided with opposite sliding planes 31 separately, that is, the first end of the hinge shaft 3 is provided with the opposite sliding plane 31, the opposite sliding plane 31 being preferably arranged in parallel, and similarly, the second end of the hinge shaft 3 is provided with the opposite sliding plane 31, the opposite sliding plane 31 being preferably arranged in parallel. In this way, it may be ensured that the hinge shaft 3 moves along the first sliding rail 12 and the second sliding rail 13 without deviation.

At least one of opposite side walls of one ends, close to the first inclined guide surface 113 and the second inclined guide surface 114, of the first sliding rail 12 and the second sliding rail 13 is provided with a limiting protrusion point 14, the limiting protrusion point 14 dividing the first sliding rail 12 and the second sliding rail 13 into upper travel sections and lower travel sections, and the lower travel sections exactly accommodating the hinge shaft 3. Preferably, both opposite side walls of the first sliding rail 12 are provided with limiting protrusion points 14, and both opposite side walls of the second sliding rail 13 are provided with limiting protrusion points 14, the limiting protrusion points 14 arranged on the opposite side walls of the first sliding rail 12 and the limiting protrusion points 14 arranged on the opposite side walls of the second sliding rail 13 having the same height. When the hinge shaft 3 passes over the limiting protrusion point 14, a prompt sound is produced, and the hinge shaft 3 is limited in the lower travel sections of the first sliding rail 12 and the second sliding rail 13.

In some example, the locking assembly further includes an actuating positioner 4, the actuating positioner 4 being connected to the fastener 2 and capable of driving the fastener 2 to move and keeping the fastener 2 at a specific position. When the actuating positioner 4 drives the fastener 2 to move to different positions, the two fastening sheets have the relative disengagement state and the relative engagement state at different positions, and may be accommodated in the retainer 1 when in the relative engagement state, the limiting structure for keeping the two fastening sheets at the specific disengagement angle is arranged between the two fastening sheets, and the limiting structure keeps the two fastening sheets in the relative disengagement state.

Particularly, the actuating positioner 4 includes a bolt 41 and a threaded through hole 42 radially formed in the hinge shaft 3, the bolt 41 penetrating the retainer 1 to be connected to the threaded through hole 42. The bolt 41 is rotated to drive the hinge shaft 3 to move, and the hinge shaft 3 and the fastener 2 move in the sliding groove 11. When the bolt 41 stops rotating, the hinge shaft 3 stops moving, and the hinge shaft 3 is positioned at a specific position, so that the locking assembly has a simple structure and a low cost.

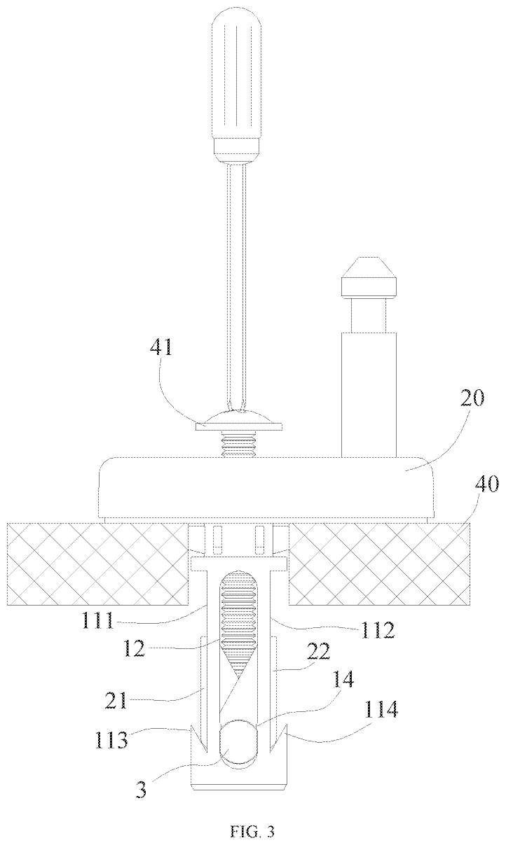

As shown in FIG. 3, when the locking assembly 10 is pre-assembled, the first fastening sheet 21, the second fastening sheet 22, and the hinge shaft 3 are installed in the retainer 1, the bolt 41 penetrates a support 20 and the retainer 1 to be in threaded connection with the threaded through hole 42 provided on the hinge shaft 3, and the first fastening sheet 21 is engaged relative to the second fastening sheet 22 and placed in the retainer 1. In such a condition, the hinge shaft 3 is limited in the lower travel sections of the first sliding rail 12 and the second sliding rail 13 and is limited by the limiting protrusion point 14, and thus the first fastening sheet 21, the second fastening sheet 22, and the hinge shaft 3 will not fall off and are integrally formed into a retainer 1 assembly, which is inserted into an installation hole of a toilet body 40.

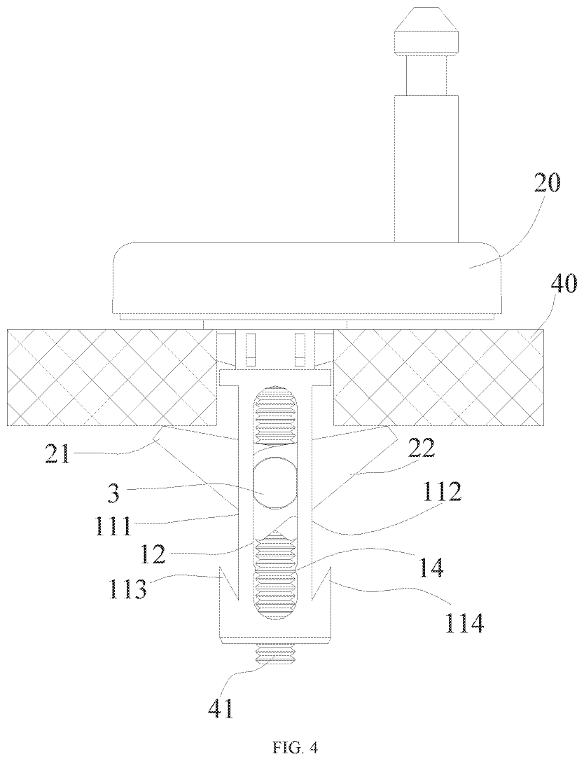

As shown in FIG. 4, when the locking assembly 10 locks, the bolt 41 is screwed, to drive the hinge shaft 3, the first fastening sheet 21, and the second fastening sheet 22 to move, the hinge shaft 3 moves upwards along the first sliding rail 12 and the second sliding rail 13 after passing over the limiting protrusion point 14, and the first end and the second end of the hinge shaft 3 are provided with the opposite sliding planes 31 separately, so as to ensure that the hinge shaft 3 may move up and down along the first sliding rail 12 and the second sliding rail 13 of the retainer 1 without deviating or falling off. The first fastening sheet 21 and the second fastening sheet 22 are disengaged to two sides under the action of gravity. The hinge shaft 3 rises continuously, disengagement angles of the first fastening sheet 21 and the second fastening sheet 22 are gradually increased, and the first fastening sheet 21 and the second fastening sheet 22 are clamped to each other through the limiting structure and kept at a specific disengagement angle. In such a condition, the first fastening sheet 21 and the second fastening sheet 22 are disengaged by a maximum angle and cannot be disengaged any more, the bolt 41 is screwed continuously, the first fastening sheet 21 and the second fastening sheet 22 abut against a lower surface of the toilet body 40, and the locking assembly 10 completely locks.

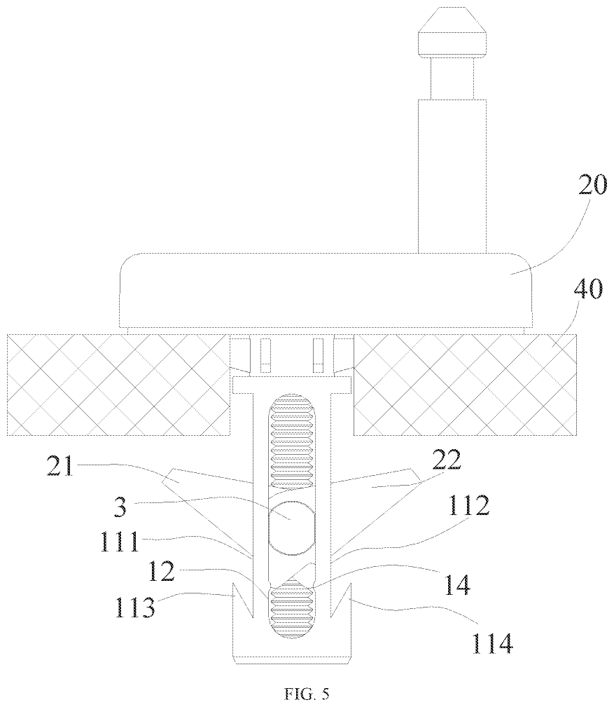

As shown in FIG. 5, when the locking assembly 10 unlocks, the bolt 41 is unscrewed, to drive the hinge shaft 3, the first fastening sheet 21, and the second fastening sheet 22 to descend until the first fastening sheet 21 and the second fastening sheet 22 make contact with the first inclined guide surface 113 and the second inclined guide surface 114 of the retainer 1 respectively, and the first fastening sheet 21 and the second fastening sheet 22 are engaged inward to be closed. When the hinge shaft 3 passes over the limiting protrusion point 14 and the bolt 41 is pressed downwards, a prompt sound showing that the hinge shaft 3 retreats to an exact position is obviously sensed. Driven by the hinge shaft 3, the first fastening sheet 21 and the second fastening sheet 22 may be completely retracted into the retainer 1, to realize unlocking.

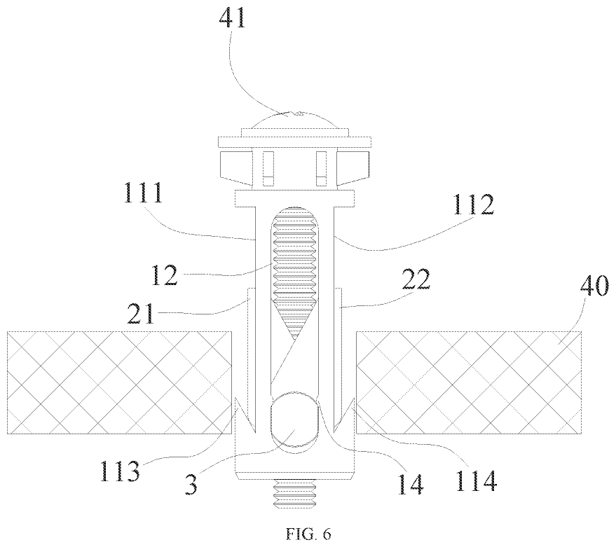

As shown in FIG. 6, the locking assembly 10 may be taken out integrally and reusable, and thus is rapidly disassembled and reusable.

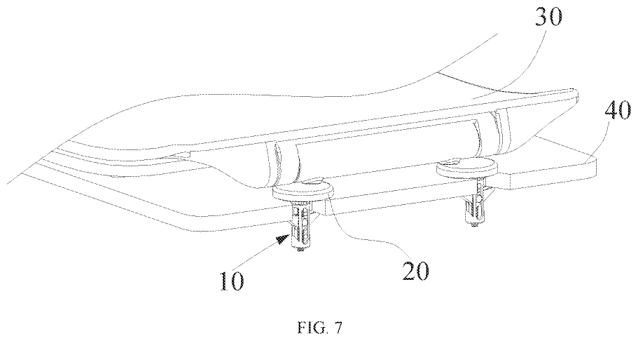

FIG. 7 is a structural schematic diagram of the locking assembly 10, installed at a toilet, in Embodiment 1. As shown in FIG. 7, a toilet in the embodiment of the present invention includes a locking assembly 10, a support 20, and a cover plate 30. The support 20 is installed on a toilet body 40 by means of the locking assembly 10, and the cover plate 30 is installed on the support 20. The locking assembly 10 includes a retainer 1 and a fastener 2, the retainer 1 being provided with a sliding groove 11, the fastener 2 being formed by hinging two fastening sheets, the two fastening sheets being capable of moving in the sliding grooves 11, having a relative disengagement state and a relative engagement state, and being capable of being accommodated in the retainer 1 when in the relative engagement state, and a limiting structure for keeping the two fastening sheets at a specific disengagement angle being arranged between the two fastening sheets.

The support 20 is installed on the toilet body 40 by means of the locking assembly 10, and the cover plate 30 is installed on the support 20. The two fastening sheets of the locking assembly are used as locking abutments, to realize a locking function when in the relative disengagement state; the two fastening sheets may be accommodated in the retainer 1 when in the relative engagement state, to reduce an entire width of the two fastening sheets, and thus it is convenient to disassemble the retainer 1 and the fastener 2 integrally, and the locking assembly is rapidly disassembled and reusable.

### Embodiment 2

The difference from Embodiment 1 is that a fastener 2 includes a third fastening sheet 23, the third fastening sheet 23 being hinged to a hinge shaft 3, and the fastener 2 being formed by one fastening sheet.

The third fastening sheet 23 includes a first hinge plate 231 and a second hinge plate 232 which are oppositely arranged, a connecting plate 233 for connecting the first hinge plate 231 and the second hinge plate 232, and an abutting plate 234 for connecting hinge ends of the first hinge plate 231 and the second hinge plate 232; an avoiding space for a bolt 41 to penetrate being arranged between the connecting plate 233 and the abutting plate 234; and a limiting structure enabling the hinge end of the connecting plate 233 to be in abutting fit with the bolt, or the abutting plate 234 to be in abutting fit with the bolt 41, or the both the hinge end of the connecting plate 233 and the abutting plate 234 to be in abutting fit with the bolt 41.

Since the fastener 2 is formed by the third fastening sheet 23 only, a corresponding sliding groove 11 may be configured as a single sliding groove, for the third fastening sheet 23 to move in the sliding groove 11. The sliding groove 11 is provided with an inclined guide surface for engaging the third fastening sheet 23.

In Embodiment 2, when the locking assembly 10 is pre-assembled, the third fastening sheet 23 and the hinge shaft 3 are installed in a retainer 1, the bolt 41 penetrates a support 20 and the retainer 1 to be in threaded connection with a threaded through hole 42 provided on the hinge shaft 3, the third fastening sheet 23 is engaged and placed in the retainer 1, in such a condition, the hinge shaft 3 is limited in lower travel sections of a first sliding rail 12 and a second sliding rail 13, and limited by a limiting protrusion point 14, and thus the third fastening sheet 23 and the hinge shaft 3 will not fall off and are integrally formed into a retainer 1 assembly, which is inserted into an installation hole of a toilet body 40.

When the locking assembly 10 locks, the bolt 41 is screwed, to drive the hinge shaft 3 and the third fastening sheet 23 to move, the hinge shaft 3 moves upwards along the first sliding rail 12 and the second sliding rail 13 after passing over the limiting protrusion point 14, a first end and a second end of the hinge shaft 3 are provided with opposite sliding planes 31 separately, so as to ensure that the hinge shaft 3 may move up and down along the first sliding rail 12 and the second sliding rail 13 of the retainer 1 without deviating and falling off. The third fastening sheet 23 is deflected and disengaged under the action of gravity. The hinge shaft 3 rises continuously, an disengagement angle of the third fastening sheet 23 is gradually increased, the third fastening sheet 23 is positioned through the limiting structure and kept at a specific disengagement angle, in such a condition, the third fastening sheet 23 is disengaged by a maximum angle and cannot be disengaged any more, the bolt 41 is screwed continuously, the third fastening sheet 23 abuts against a lower surface of the toilet body 40, and the locking assembly 10 completely locks.

When the locking assembly 10 unlocks, the bolt 41 is unscrewed, to drive the hinge shaft 3 and the third fastening sheet 23 to descend until the third fastening sheet 23 makes contact with a first inclined guide surface 113 of the retainer 1, and the third fastening sheet 23 is engaged inward. When the hinge shaft 3 passes over the limiting protrusion point 14 and the bolt 41 is pressed downwards, a prompt sound showing that the hinge shaft 3 retreats to an exact position is obviously heard. Driven by the hinge shaft 3, the third fastening sheet 23 may be completely retracted into the retainer 1, to realize unlocking. The locking assembly 10 may be taken out integrally and reusable.

In the description of the present invention, it is to be understood that the terms “central”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, etc. indicate azimuthal or positional relations based on those shown in the accompanying drawings only for ease of description of the present invention and for simplicity of description, and are not intended to indicate or imply that the referenced device or element must have a particular orientation and be constructed and operative in a particular orientation, and thus may not be construed as a limitation on the present invention.

In addition, the terms “first” and “second” are for descriptive purposes only and are not to be construed as indicating or implying the relative importance or implicitly specifying the number of indicated technical features. Thus, a feature defined with “first” and “second” may explicitly or implicitly include one or more of the feature. In the description of the present invention, “plurality” means two or more, unless expressly specified otherwise.

In the present invention, unless expressly specified and limited otherwise, the terms “install”, “connect”, “connected”, “fix”, etc. are to be construed broadly and, for example, may be fixedly connected, or detachably connected, or integrally formed; may be mechanically connected, or electrically connected; and may be direct connected or indirect connected via an intermediary medium, or may be an internal communication between two elements or an interworking relation between two elements. The specific meanings of the terms described above in the present invention may be understood on a case-by-case basis for those of ordinary skill in the art.

In the present invention, unless expressly specified and limited otherwise, a case that a first feature is “above” or “below” a second feature may be direct contact between the first and second features, or contact between the first and second features through another feature therebetween, not direct contact. Also, a case that the first feature is “above”, “on the upper portion of”, and “on” the second feature may be that the first feature is right above and diagonally above the second feature, or simply indicates that a horizontal height of the first feature is higher than that of the second feature. A case that the first feature is “below”, “on the lower portion of”, and “underneath” the second feature may be that the first feature is right below and diagonally below the second feature, or simply indicates that a horizontal height of the first feature is lower than that of the second feature.

In the description of the present description, the descriptions with reference to terms such as “an embodiment”, “some embodiments”, “examples”, “specific examples”, or “some examples” mean that specific features, structures, materials, or characteristics described in combination with the embodiment(s) or example(s) are included in at least one embodiment or example of the present invention. In the present description, the schematic expressions of the terms described above are not necessarily directed to the same embodiment or example. Moreover, the specific feature, structure, material or characteristic described may be combined in a suitable manner in any one or more embodiments or examples. In addition, a person skilled in the art may bind and combine different embodiments or examples described in the present description.

While the embodiment of the present invention has been illustrated and described above, it is to be understood that the embodiment described above is exemplary and is not to be construed as limiting the present invention; and variations, modifications, substitutions and alterations to the embodiment described above may be made by those of ordinary skill in the art within the scope of the present invention.

What is claimed is:

1. A locking assembly, comprising:
a retainer, wherein the retainer is provided with a sliding groove; and
a fastener, wherein the fastener is configured to move in the sliding groove, the fastener has a relative disengagement state and a relative engagement state, the fastener is configured to be accommodated in the retainer when in the relative engagement state, and the fastener is provided with a limiting structure for keeping the fastener at a specific disengagement angle.

2. The locking assembly according to claim 1, wherein
the fastener is hinged to a hinge shaft, and the hinge shaft is configured to move in the sliding groove.

3. The locking assembly according to claim 2, wherein
the retainer is provided with a first sliding rail and a second sliding rail, wherein
the first sliding rail and the second sliding rail are oppositely arranged and in communication with each other,
a first end of the hinge shaft moves in the first sliding rail,
a second end of the hinge shaft moves in the second sliding rail, and
the first end and the second end of the hinge shaft are provided with opposite sliding planes separately.

4. The locking assembly according to claim 3, wherein
at least one of opposite side walls of one ends of the first sliding rail and the second sliding rail is provided with a limiting protrusion point, wherein the one ends of the first sliding rail and the second sliding rail are adjacent to a first inclined guide surface and a second inclined guide surface; and
the limiting protrusion point divides the first sliding rail and the second sliding rail into upper travel sections and lower travel sections, and the lower travel sections exactly accommodate the hinge shaft.

5. The locking assembly according to claim 1, further comprising an actuating positioner, wherein
the actuating positioner is connected to the fastener and is configured to drive the fastener to move and keep the fastener at a specific position.

6. The locking assembly according to claim 5, wherein
the actuating positioner comprises a bolt and a threaded through hole radially formed in the hinge shaft, wherein the bolt penetrates the retainer to be connected to the threaded through hole.

7. The locking assembly according to claim 6, wherein
the fastener comprises a first fastening sheet and a second fastening sheet, wherein the first fastening sheet and the second fastening sheet are hinged to the hinge shaft separately.

8. The locking assembly according to claim 7, wherein
each of the first fastening sheet and the second fastening sheet comprises a first hinge plate, a second hinge plate, and a connecting plate for connecting the first hinge plate to the second hinge plate, wherein the first hinge plate and the second hinge plate are oppositely arranged;
a part of the connecting plate of the first fastening sheet is provided with a first cut groove, wherein the part of the connecting plate of the first fastening sheet is adjacent to a hinge end of the first fastening sheet, and a part of the connecting plate of the second fastening sheet is provided with a second cut groove, wherein the part of the connecting plate of the second fastening sheet is adjacent to a hinge end of the second fastening sheet; and
the limiting structure allows an end part of a hinge end of the first hinge plate of the first fastening sheet to be in abutting fit with a bottom of the second cut groove of the second fastening sheet, and an end part of a hinge end of the first hinge plate of the second fastening sheet to be in abutting fit with a bottom of the first cut groove of the first fastening sheet.

9. The locking assembly according to claim 8, wherein
the sliding grooves comprise a first sliding groove and a second sliding groove, wherein the first sliding groove and the second sliding groove are oppositely arranged and in communication with each other;
the first fastening sheet moves in the first sliding groove, and the second fastening sheet moves in the second sliding groove; and
the first sliding groove is provided with a first inclined guide surface for engaging the first fastening sheet relative to the second fastening sheet, and the second sliding groove is provided with a second inclined guide surface for engaging the second fastening sheet relative to the first fastening sheet, wherein the first inclined guide surface is opposite to the second inclined guide surface.

10. The locking assembly according to claim 6, wherein
the fastener comprises a third fastening sheet, wherein the third fastening sheet is hinged to the hinge shaft.

11. The locking assembly according to claim 10, wherein
the third fastening sheet comprises a first hinge plate, a second hinge plate, a connecting plate for connecting the first hinge plate to the second hinge plate, and an abutting plate for connecting hinge ends of the first hinge plate and the second hinge plate, wherein the first hinge plate and the second hinge plate are oppositely arranged;
an avoiding space for the bolt to penetrate is arranged between the connecting plate and the abutting plate; and
the limiting structure allows a hinge end of the connecting plate and/or the abutting plate to be in abutting fit with the bolt.

12. The locking assembly according to claim 2, further comprising an actuating positioner, wherein
the actuating positioner is connected to the fastener and is configured to drive the fastener to move and keep the fastener at a specific position.

13. The locking assembly according to claim 3, further comprising an actuating positioner, wherein
the actuating positioner is connected to the fastener and is configured to drive the fastener to move and keep the fastener at a specific position.

14. The locking assembly according to claim 4, further comprising an actuating positioner, wherein
the actuating positioner is connected to the fastener and is configured to drive the fastener to move and keep the fastener at a specific position.
